(19) United States
(12) Patent Application Publication
(10) Pub. No.: US 2024/0006973 A1
(43) Pub. Date: Jan. 4, 2024

(54) PERMANENT FIELD MAGNET AND LINEAR MOTOR

(71) Applicant: FUJI ELECTRIC CO., LTD., Kanagawa (JP)

(72) Inventors: Terukazu AKIYAMA, Tokyo (JP); Satoshi IMAMORI, Tokyo (JP)

(21) Appl. No.: 18/305,613

(22) Filed: Apr. 24, 2023

(30) Foreign Application Priority Data
Jul. 4, 2022 (JP) 2022-107985

(51) Int. Cl. H02K 41/03

(52) U.S. Cl. CPC H02K 41/031

(57) ABSTRACT

A permanent field magnet for a linear motor is provided. The permanent field magnet includes a plurality of permanent magnets arranged along a moving path of a mover; a first member that includes a soft magnetic material and is disposed between and in contact with mutually adjacent ones of the plurality of permanent magnets; and a suppressing portion configured to suppress application of a magnetic field from an armature to each of the permanent magnets.

### CROSS-REFERENCE TO RELATED APPLICATIONS

This application is based on and claims priority to Japanese Patent Application No. 2022-107985, filed on Jul. 4, 2022, the entire contents of which are incorporated herein by reference.

### BACKGROUND OF THE INVENTION

### 1. Field of the Invention

The disclosure herein relates to a permanent field magnet for a linear motor.

### 2. Description of the Related Art

For example, a technique by which the surfaces of permanent magnets included in a permanent field magnet for a linear motor are covered by a soft magnetic material so as to suppress magnetization is known (see Patent Document 1 to 4).

However, permanent field magnets described in Patent Documents 1 to 4 do not have saliency and thus cannot utilize a reluctance force.

### RELATED-ART DOCUMENTS

### Patent Documents

Patent Document 1: Japanese Laid-open Patent Publication No. 2020-120471
Patent Document 2: Japanese Laid-open Patent Publication No. 2019-154141
Patent Document 3: Japanese Laid-open Patent Publication No. 2009-148153
Patent Document 4: International Publication Pamphlet No. WO 2019/167397

### SUMMARY OF THE INVENTION

It is desirable to provide a technique by which demagnetization of a permanent field magnet having saliency can be suppressed.

According to one embodiment of the present disclosure, a permanent field magnet for a linear motor is provided. The permanent field magnet includes a plurality of permanent magnets arranged along a moving path of a mover; a first member that includes a soft magnetic material and is disposed between and in contact with mutually adjacent ones of the plurality of permanent magnets; and a suppressing portion configured to suppress application of a magnetic field from an armature to each of the permanent magnets.

According to another embodiment of the present disclosure, the linear motor including the above-described permanent field magnet and the armature is provided.

### BRIEF DESCRIPTION OF THE DRAWINGS

Other objects and further features of the present invention will be apparent from the following detailed description when read in conjunction with the accompanying drawings, in which:

FIG. 1 is a side cross-sectional view of an example of a linear motor;

FIG. 2 is a plan cross-sectional view of an example of an armature;

FIG. 3 is a side view illustrating a first example of a field magnet;

FIG. 4 is a diagram illustrating an example of demagnetization analysis results of a field magnet according to a comparative example;

FIG. 5 is a side view illustrating a second example of the field magnet;

FIG. 6 is a side view illustrating a third example of the field magnet; and

FIG. 7 is a side view illustrating a fourth example of the field magnet.

### DESCRIPTION OF THE EMBODIMENTS

According to an embodiment of the present disclosure, demagnetization of a permanent field magnet having saliency can be suppressed.

In the following, embodiments of the present disclosure will be described with reference to the accompanying drawings.

### [Overview of Linear Motor]

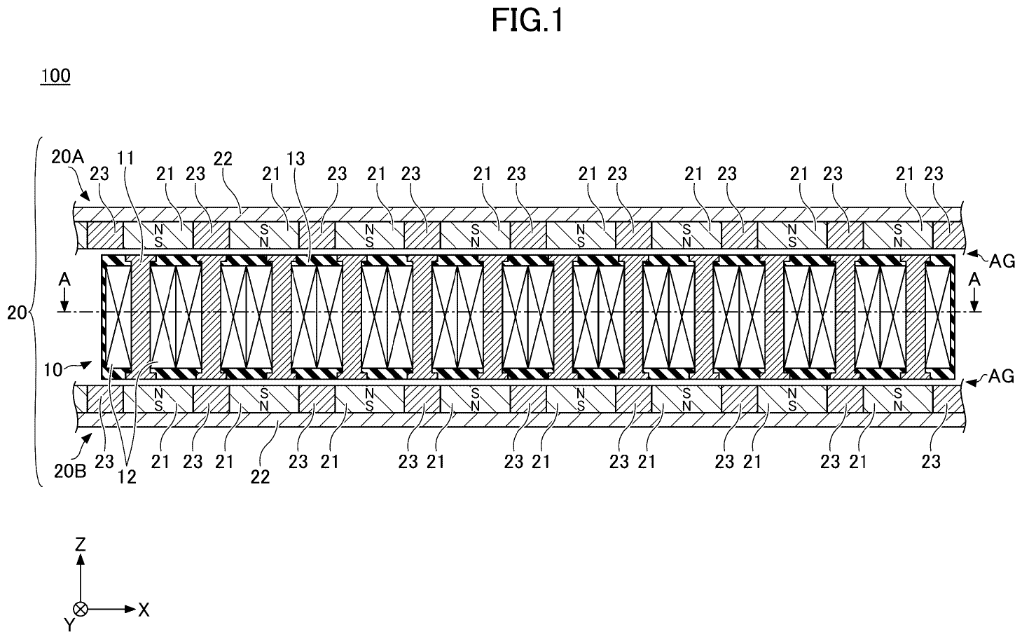

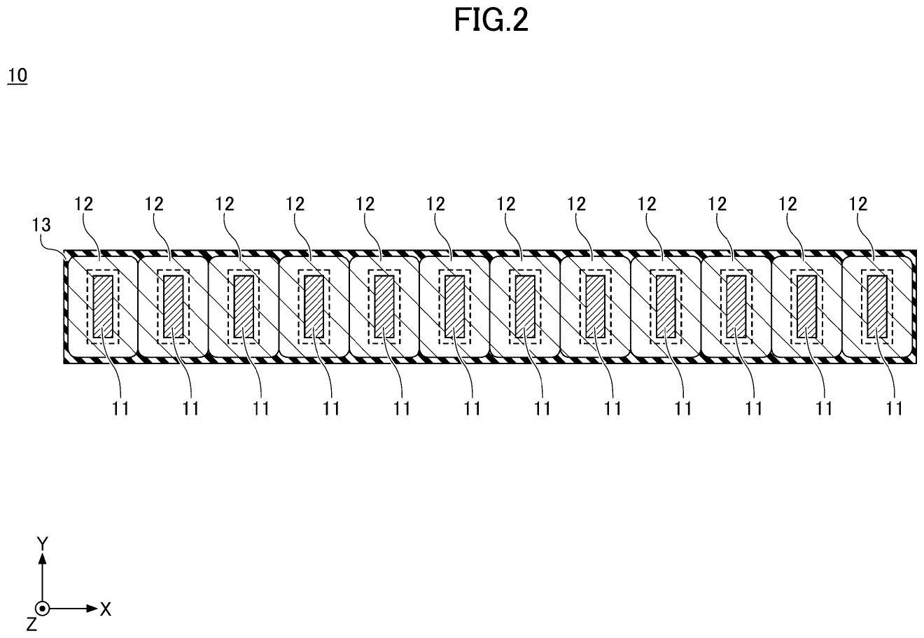

An overview of a linear motor 100 according an embodiment will be described with reference to FIG. 1 and FIG. 2.

FIG. 1 is a side cross-sectional view of an example of the linear motor 100. Specifically,

FIG. 1 is a cross-sectional view of the linear motor 100 taken along a plane parallel to the X-axis and the Z-axis. FIG. 2 is a plan cross-sectional view of an example of an armature 10. Specifically, FIG. 2 is a cross-sectional view of the armature 10 taken through A-A of FIG. 1.

In the following description, an orthogonal coordinate system defined by the X-axis, the Y-axis, and the Z-axis in the drawings may be used. Further, a positive X-axis direction and a negative X-axis direction may be collectively referred to as an X-axis direction. A positive Y-axis direction and a negative Y-axis direction may be collectively referred to as a Y-axis direction. A positive Z-axis direction and a negative Z-axis direction may be collectively referred to as a Z-axis direction.

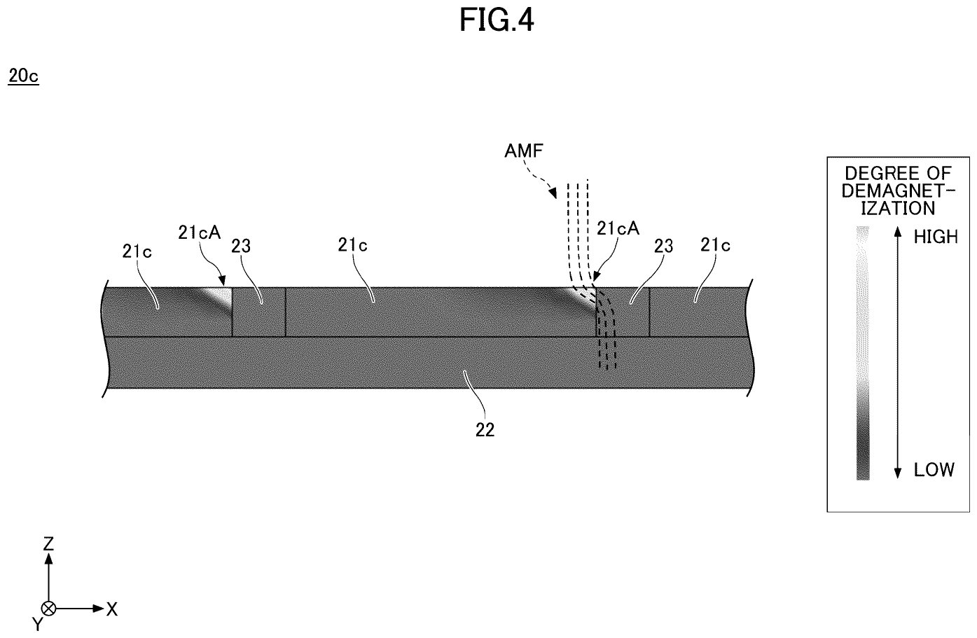

Note that, in FIG. 1, an overview of a field magnet 20 is depicted, and the detailed structure of the field magnet 20 is omitted (see FIG. 4 and FIGS. 5 to 7).

The linear motor 100 according to the present embodiment may be incorporated into any of opening/closing mechanisms of various sliding doors, such as railway vehicle doors and platform doors of railway stations. The linear motor 100 according to the present embodiment may be mounted, for example, in a machine tool such as a semiconductor manufacturing apparatus or a machining center.

As illustrated in FIG. 1 and FIG. 2, the linear motor 100 includes the armature 10 and the field magnet 20. In FIG. 1, letters “N” and “S” indicated on the field magnet 20 represent magnetic poles (an N-pole and an S-pole) of a permanent magnet 21. In FIG. 2, a dashed line indicated on the armature 10 represents the cross-sectional shape of each end of a core 11 in the Z-axis direction.

The armature 10 is disposed to face a field magnet section 20A and a field magnet section in the Z-axis direction via predetermined gaps (also referred to as “air gaps”) AG. In this example, the armature 10 is a mover. The armature is supported so as to be movable in the X-axis direction by, for example, a support mechanism such as a slide rail or a linear guide. Therefore, the armature 10 can move in the X-axis direction by a force magnetically acting between the armature 10 and the field magnet 20. The armature 10 includes the core (also referred to as an “iron core”) 11, a coil (also referred to as a “winding”) 12, and a holding section 13.

The core 11 functions as a magnetic path of a magnetic field generated by the armature current of the coil 12 and a magnetic field from the permanent magnet 21 of the field magnet 20. The core 11 is formed of a soft magnetic material. The soft magnetic material used for the core 11 is, for example, an iron-based material such as cast iron or structural steel. The soft magnetic material used for the core 11 may be a functional material such as an electromagnetic steel plate or a magnetic powder core. In this example, a plurality of (12) cores 11 are provided, and the number of the cores 11 are the same as the number of coils 12.

For example, as illustrated in FIG. 1 and FIG. 2, each of the cores 11 has a rectangular column shape extending in the Z-axis direction, and is formed so as to have a larger cross-sectional shape at both ends than in the center in the Z-axis direction. With this configuration, for example, even if the cores 11 attempt to move in the positive Z-axis direction, the ends on the negative Z-axis side of the cores 11 contact the holding section 13, thereby preventing the cores 11 from moving in the positive Z-axis direction. Therefore, falling-off of the cores 11 from the armature 10 due to the movement of the cores 11 in the positive Z-axis direction can be avoided. In addition, falling-off of the cores 11 from the armature 10 due to the movement of the cores 11 in the negative Z-axis direction can also be avoided by the same effect.

When the armature current flows through each of the coils 12, thrust is generated in the mover (armature 10) by the interaction with a magnetic field generated from each of the magnet sections 20A and 20B. The coils 12 are formed by winding conductive wires around the cores 11.

In this example, the plurality of (12) coils 12 are provided. The plurality of coils 12 are arranged in the X-axis direction. For example, three-phase alternating current (AC) power of U-phase, V-phase, and W-phase is supplied to the plurality of coils 12. Specifically, in FIG. 1, the three-phase AC power may be supplied from a coil 12, located at the end on the negative X-axis side, toward the positive X-axis side in the order of U-phase, V-phase, W-phase, U-phase, V-phase, W-phase, and so on. However, the order in which the power of U-phase, V-phase, and W-phase is supplied to the plurality of coils 12 is merely an example, and the order may be changed as appropriate according to the specifications of the linear motor 100 (for example, according to the arrangement relationship between the number of poles of permanent magnets 21 and the number of slots of coils 12 in the X-axis direction).

An insulating section (not illustrated) is provided between each of the cores 11 and a corresponding coil 12 (conductive wire) so as to ensure mutual insulation. The insulating section is, for example, an insulating member that ensures insulation between each of the cores 11 and the corresponding coil 12, such as insulating paper, an insulator, a bobbin, or an insulating coating on the surface of each of the cores 11. The insulating coating of each of the cores 11 is, for example, insulation powder coating. The insulating section may be an insulation film coated on the conductive wire of the corresponding coil 12.

The number of coils 12 may be 11 or less or may be 13 or more.

The holding section 13 integrally holds the plurality of cores 11 and the plurality of coils 12. The holding section 13 is formed of a mold resin, and both ends of each of the cores 11 in the axial direction (in the Z-axis direction) are held so as to be exposed from the holding section 13.

The field magnet 20 generates a magnetic field acting on the armature 10. In this example, the field magnet 20 is a stator. As illustrated in FIG. 1, the field magnet 20 extends in the X-axis direction, and the dimension of the field magnet 20 in the X-axis direction is defined in accordance with the amount of movement of the armature 10, which serves as the mover, in the X-axis direction.

The field magnet 20 includes the field magnet sections 20A and 20B.

The field magnet sections 20A and 20B extend in the X-axis direction substantially parallel to each other. The term “substantially” is intended to tolerate a manufacturing error and the like and is used in the same meaning in the following. A predetermined space is provided between the field magnet sections 20A and 20B in the Z-axis direction, and the space is set to be greater than the dimension of the armature 10 in the Z-axis direction to some extent. For example, the space between the field magnet sections 20A and 20B corresponds to an amount calculated by adding the movable amount of the support mechanism (e.g., the slide rail or the linear guide) of the armature 10 in the Z-axis direction and a predetermined margin to the dimension of the armature 10 in the Z-axis direction. Accordingly, the armature 10, which serves as the mover, can move in the X-axis direction without contacting the field magnet sections 20A and 20B.

The field magnet section 20A and the field magnet section 20B are disposed to face the positive Z-axis side and the negative Z-axis side of the armature 10, respectively. Each of the field magnet sections 20A and 20B generates magnetic flux linked with the plurality of coils 12 of the armature 10.

Each of the field magnet sections 20A and 20B includes a plurality of permanent magnets 21, a back yoke 22, and a soft magnetic member 23.

The plurality of permanent magnets 21 are arranged in the X-axis direction so as to face the armature 10 in the Z-axis direction. For example, as illustrated in FIG. 1, the plurality of permanent magnets 21 are arranged in the X-axis direction at substantially equal intervals, and each of the permanent magnets 21 has a substantially rectangular parallelepiped shape having sides extending along the X-axis direction, the Y-axis direction, and the Z-axis direction. The plurality of permanent magnets 21 are magnetized in the Z-axis direction in which the field magnet 20 and the armature 10 face each other. Further, the plurality of permanent magnets 21 are disposed such that the magnetic poles of the end surfaces, facing the armature 10 in the Z-axis direction, of permanent magnets 21 that are adjacent to each other in the X-axis direction differ from each other. The plurality of permanent magnets 21 are, for example, neodymium sintered magnets, ferrite magnets, or the like.

The field magnet section 20A and the field magnet section 20B are configured such that the magnetic specifications (e.g., the shape, the dimensions, the residual magnetic flux density, and the like) and the arrangement specifications (e.g., the arrangement positions of the permanent magnets 21 in the X-axis direction, a manner of arrangement including the presence or absence of the Halbach array, and the like) of the permanent magnets 21 are substantially the same. Accordingly, the field magnet section 20A and the field magnet section 20B can generate substantially symmetrical magnetic fields in the space between the field magnet section and the field magnet section 20B, which face each other in the Z-axis direction.

The back yoke 22 is disposed adjacent to the end surfaces of the permanent magnets 21 opposite to the end surfaces facing the armature 10 in the Z-axis direction. The back yoke 22 functions as a magnetic path between mutually adjacent permanent magnets 21. The back yoke 22 is formed of a soft magnetic material. The soft magnetic material used for the back yoke 22 is, for example, an iron-based material such as cast iron or structural steel. The soft magnetic material used for the back yoke 22 may be a functional material such as an electromagnetic steel plate or a magnetic powder core.

The soft magnetic member 23 is formed of a soft magnetic material, and is disposed between and in contact with mutually adjacent permanent magnets 21 in the X-axis direction. For example, the soft magnetic material is an iron-based material such as cast iron or structural steel. The soft magnetic material may be a functional material such as an electromagnetic steel plate or a magnetic powder core. For example, as illustrated in FIG. 1, the soft magnetic member 23 has a substantially rectangular parallelepiped shape having sides extending in the X-axis direction, the Y-axis direction, and the Z-axis direction. Both ends of the soft magnetic member 23 in the X-axis direction contact the permanent magnets 21 that are adjacent to each other. Accordingly, the field magnet sections 20A and 20B can have saliency in which the magnetic reluctance with respect to the magnetic field of the armature 10 varies in the X-axis direction, which is the moving direction of the mover (armature 10). Therefore, the linear motor 100 can utilize, as thrust, not only the magnetic force between the armature 10 and the field magnet but also the reluctance force. Accordingly, the thrust of the linear motor 100 can be improved. Further, by utilizing the saliency of the field magnet 20 (field magnet sections 20A and 20B), the position of the mover (armature 10) in the X-axis direction can be estimated, and thus, sensors such as encoders for detecting the position of the armature 10 can be omitted.

### [First Example of Field Magnet]

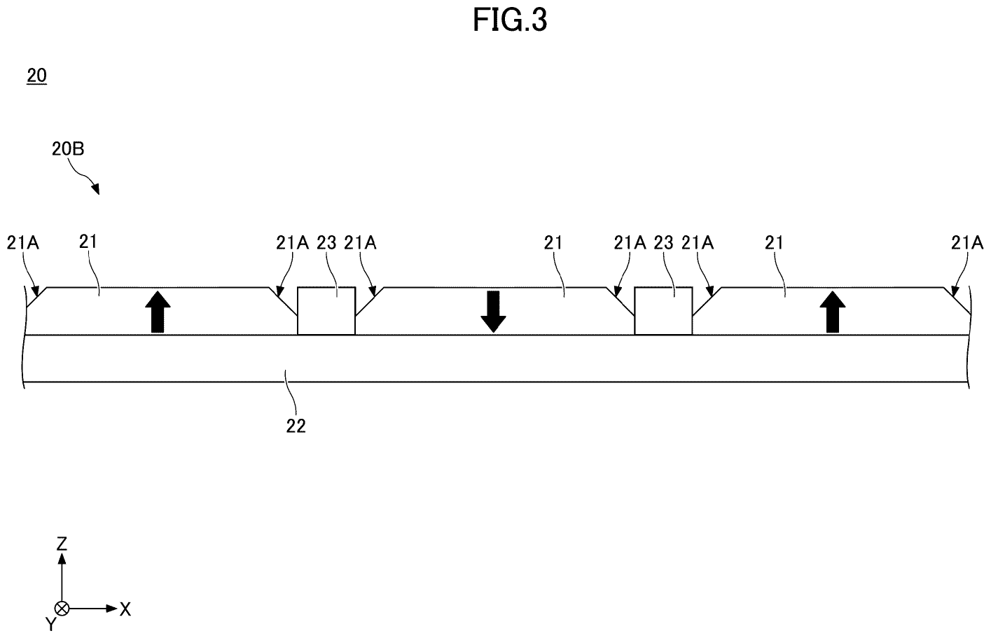

Next, a first example of the field magnet according to the present embodiment will be described with reference to FIG. 3 and FIG. 4.

FIG. 3 is a side view illustrating the first example of the field magnet 20. FIG. 4 is a diagram illustrating an example of demagnetization analysis results of a field magnet 20c according to a comparative example. Specifically, FIG. 4 is a diagram illustrating a specific example of demagnetization analysis results of a field magnet when the mover (armature 10) moves in the positive X-axis direction.

Note that, in FIG. 3, only the field magnet section 20B is depicted and the field magnet section 20A is not depicted. Further, black arrows in FIG. 3 indicate magnetization directions of the permanent magnets 21.

As illustrated in FIG. 3, in this example, each of the permanent magnets 21 has chamfered portions 21A obtained by chamfering corner portions at both ends in the X-axis direction of the end surface, facing the armature 10 in the Z-axis direction, of each of the permanent magnets 21 in a planar shape.

For example, as illustrated in FIG. 4, the field magnet 20c employs a permanent magnet 21c that has an unchamfered corner portion 21cA at each end in the X-axis direction of the end surface, facing an armature 10 in the Z-axis direction, of the permanent magnet 21c. In the field magnet 20c, the corner portion 21cA has a very high degree of demagnetization. This is because, although magnetic flux AMF from a coil 12, located so as to overlap the permanent magnets 21c in the X-axis direction, changes the direction so as to flow into a soft magnetic member 23 having relatively low magnetic reluctance, a portion of the magnetic flux AMF passes through the corner portion 21cA of the permanent magnet 21c. Therefore, demagnetization at the corner portion 21cA may progress due to the influence of the magnetic flux of the armature 10 applied to the corner portion 21cA, and demagnetization may also propagate to the vicinity of the corner portion 21cA to which the magnetic flux is applied, and as a result, demagnetization of the permanent magnet 21c may progress.

Conversely, in the first example, demagnetization of the permanent magnets 21 can be suppressed by providing a chamfered portion 21A obtained by chamfering a portion corresponding to the corner portion 21cA. Further, the portion of each of the permanent magnets 21, corresponding to the corner portion 21cA, corresponds to a harmonic component of a magnetic flux density waveform of the field magnet 20 (field magnet sections 20A and 20B) in the X-axis direction. Therefore, even if each of the permanent magnets 21 is provided with the chamfered portion 21A obtained by chamfering the portion corresponding to the corner portion 21cA, the influence on the thrust of the linear motor 100 can be suppressed. That is, in this example, demagnetization of the permanent magnets 21 can be suppressed while the influence on the thrust of the linear motor 100 can be suppressed.

Further, the harmonic component of the magnetic flux density waveform of the field magnet (field magnet sections 20A and 20B) in the X-axis direction can be suppressed by providing each of the permanent magnets 21 with the chamfered portion 21A obtained by chamfering the portion corresponding to the corner portion 21cA. As a result, cogging of the linear motor 100 can be suppressed.

### [Second Example of Field Magnet]

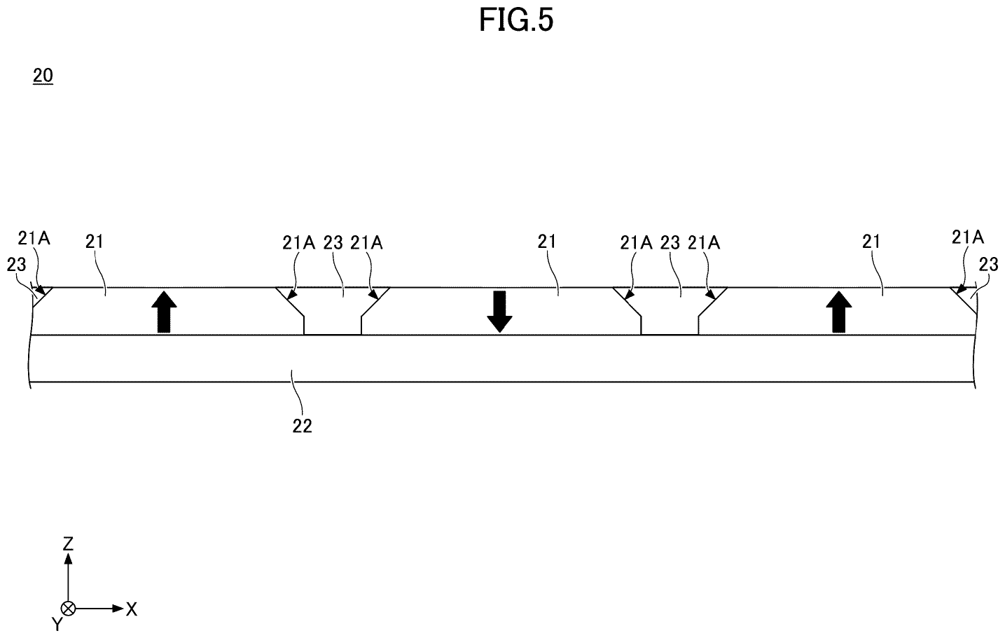

Next, a second example of the field magnet 20 according to the present embodiment will be described with reference to FIG. 5.

In the following, parts different from the above-described first example will be mainly described, and the description of the same or corresponding parts as the first example may be simplified or omitted.

FIG. 5 is a side view illustrating the second example of the field magnet 20.

Note that, in FIG. 5, only the field magnet section 20B is depicted and the field magnet section 20A is not depicted. Further, black arrows in FIG. 5 indicate magnetization directions of the permanent magnets 21.

As illustrated in FIG. 5, similar to the above-described first example, chamfered portions 21A are provided at both ends in the X-axis direction of the end surface, facing the armature 10 in the Z-axis direction, of each of the permanent magnets 21.

Unlike the above-described first example, the soft magnetic member 23 is formed in contact with chamfered portions 21A of two adjacent permanent magnets 21. Specifically, the soft magnetic member 23 is formed such that each end surface in the X-axis direction of the soft magnetic member 23 extends to an area where a corner portion of an adjacent permanent magnet 21 is chamfered, and contacts a chamfered portion 21A of the adjacent permanent magnet 21. Accordingly, the magnetic flux of the armature 10 can be more readily concentrated in the soft magnetic member 23 by the effect of the extended portion of the soft magnetic member 23, thereby improving the reluctance force. Therefore, the thrust of the linear motor 100 can be improved.

### [Third Example of Field Magnet]

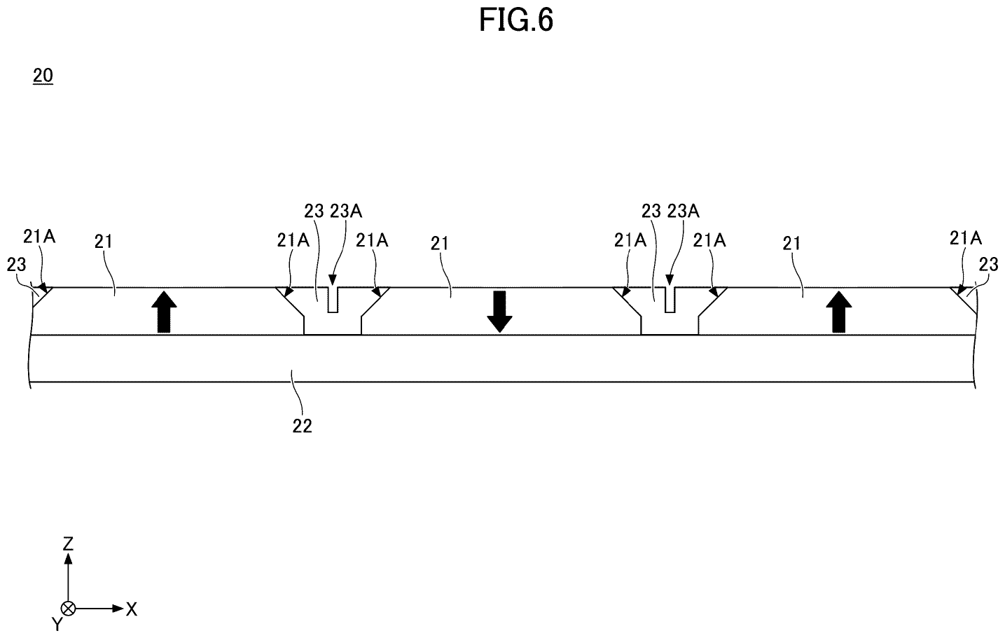

Next, a third example of the field magnet 20 according to the present embodiment will be described with reference to FIG. 6.

In the following, parts different from the first example and the second example described above will be mainly described, and the description of the same or corresponding parts as the first example and the second example described above may be simplified or omitted.

FIG. 6 is a side view illustrating the third example of the field magnet 20.

Note that, in FIG. 6, only the field magnet section 20B is depicted and the field magnet section 20A is not depicted. Further, black arrows in FIG. 6 indicate magnetization directions of the permanent magnets 21.

In this example, similar to the first example and the second example described above, chamfered portions 21A are provided at both ends in the X-axis direction of the end surface, facing the armature 10 in the Z-axis direction, of each of the permanent magnets 21.

Similar to the above-described second example, the soft magnetic member 23 is formed in contact with chamfered portions 21A of mutually adjacent permanent magnets 21.

Further, in this example, unlike the first example and the second example described above, the soft magnetic member 23 has a groove 23A.

The groove 23A is provided so as to extend across the end surface, facing the armature 10 in the Z-axis direction, of the soft magnetic member 23 in a direction (the Y-axis direction, for example) intersecting the X-axis direction. Accordingly, the groove 23A can be interposed between the chamfered portions 21A of the mutually adjacent permanent magnets 21 having magnetic poles of different polarities. Therefore, a decrease in the thrust of the linear motor 100 due to a short circuit of magnetic flux between the chamfered portions 21A of the mutually adjacent permanent magnets 21 having magnetic poles of different polarities can be suppressed.

The specifications such as the shape and the dimensions of the groove 23A are determined based on computer simulations, for example. Specifically, the dimension (width) in the X-axis direction and the dimension (depth) in the Z-axis direction of the groove 23A may be determined by computer simulations such as electromagnetic field analysis. In such a case, for example, the dimension (width) in the X-axis direction and the dimension (depth) in the Z-axis direction of the groove 23A are determined such that the amplitude of the fundamental wave of a magnetic flux density waveform on the end surface in the Z-axis direction of each of the permanent magnets 21 is maximized.

### [Fourth Example of Field Magnet]

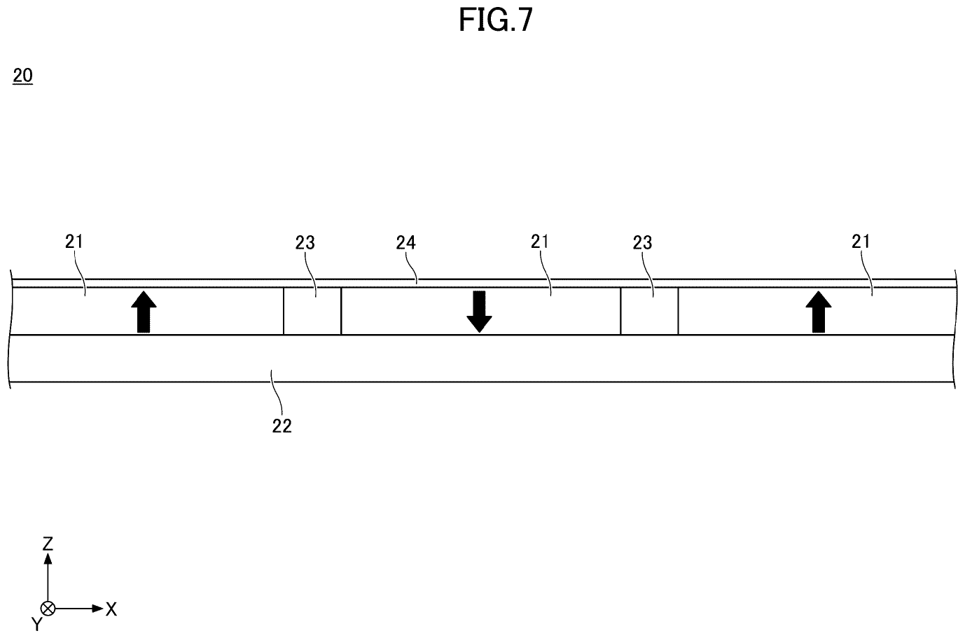

Next, a fourth example of the field magnet according to the present embodiment will be described with reference to FIG. 7.

In the following, parts different from the first example to the third example described above will be mainly described, and the description of the same or corresponding parts as the first example to the third example described above may be simplified or omitted.

FIG. 7 is a side view illustrating the fourth example of the field magnet 20.

Note that, in FIG. 7, only the field magnet section 20B is depicted and the field magnet section 20A is not depicted. Further, black arrows in FIG. 7 indicate magnetization directions of the permanent magnets 21.

In this example, unlike the first example to the third example described above, a soft magnetic member 24 is provided.

The soft magnetic member 24 is formed of a soft magnetic material, and is provided so as to cover the surfaces, facing the armature 10 in the Z-axis direction, of the permanent magnets 21 and the soft magnetic member 23. For example, the soft magnetic material is an iron-based material such as cast iron or structural steel. The soft magnetic material may be a functional material such as an electromagnetic steel plate or a magnetic powder core. Accordingly, most of the magnetic flux of the armature 10 can pass through the soft magnetic member 24 and the soft magnetic member 23 without being directly applied to the permanent magnets 21. Therefore, demagnetization of the permanent magnets 21 can be suppressed.

The soft magnetic member 24 may have a flat plate shape having a relatively small dimension in the Z-axis dimension and extending in the X-axis direction and the Y-axis direction. For example, the dimension (thickness) in the Z-axis direction of the soft magnetic member 24 is smaller than the dimensions in the Z-axis direction of the permanent magnets 21 and the back yoke 22. The thickness in the Z-axis direction of the soft magnetic member 24 may be smaller than the dimensions in the Z-axis direction of the permanent magnets 21 and the back yoke 22 and greater than the dimension in the Z-axis direction of the air gaps AG between the armature 10 and the field magnet sections 20A and 20B. The thickness in the Z-axis of the soft magnetic member 24 may be smaller than or equal to the dimension in the Z-axis direction of the air gaps AG. Accordingly, a situation in which magnetic flux between mutually adjacent permanent magnets 21 having magnetic poles of different polarities is short-circuited through the soft magnetic member 24 can be avoided.

### OTHER EMBODIMENTS

The above-described first to fourth examples of the embodiment may be appropriately varied or modified.

For example, in the above-described first to third examples of the field magnet 20 according to the embodiment, a chamfered portion 21A may be provided at only one end of the two ends in the X-axis direction of each of the permanent magnets 21. For example, if demagnetization tends to occur at the end on the positive X-axis side of each of the permanent magnets 21 as in the case of FIG. 4, each of the permanent magnets 21 may be provided with a chamfered portion 21A only at the end on the positive X-axis side among the two ends on the positive and negative X-axis sides. The same may apply to a case where demagnetization tends to occur at the end on the negative X-axis side of each of the permanent magnets 21. Accordingly, for example, the number of man-hours required to form a chamfered portion 21A for each of the permanent magnets 21 can be reduced. Examples of a case where demagnetization tends to occur only at one of the two ends on the positive and negative X-axis sides of each of the permanent magnets 21 include, for example, a case where the mover (armature 10) moves in one of the positive and negative X-axis directions. Further, examples of a case where demagnetization tends to occur only at one end of the two ends on the positive and negative X-axis sides of each of the permanent magnets 21 include, for example, a case where the mover moves in both the positive and negative X-axis directions, but relatively large thrust is generated in only one of the positive and negative X-axis directions.

Further, in the above-described first to third examples of the field magnet 20 according to the embodiment and modifications thereof, a chamfered portion 21A may be chamfered in a curved shape.

Further, in the above-described fourth example of the field magnet 20 according to the embodiment, the soft magnetic member 24 may be provided for each of the permanent magnets 21. In this case, the soft magnetic member 24 is disposed to cover the entire surface of a corresponding permanent magnet 21 and the surface of a portion of the soft magnetic member 23 that is adjacent to the corresponding permanent magnet 21, and to be apart from another soft magnetic member 24 that covers the surface of another permanent magnet 21 that is adjacent to the corresponding permanent magnet 21. Accordingly, a situation in which magnetic flux between mutually adjacent permanent magnets 21 having magnetic poles of different polarities is short-circuited through the soft magnetic member 24 can be avoided.

Further, in the above-described third example of the field magnet 20 according to the embodiment, the groove 23A does not necessarily extend across the end surface, facing the armature in the Z-axis direction, of the soft magnetic member 23, and at least one of the two ends in the Y-axis direction of the groove 23A may be located inward relative to the corresponding end in the Y-axis direction of the soft magnetic member 23.

Further, in the above-described embodiment and modifications thereof, either the field magnet section 20A or the field magnet section 20B may be omitted.

Further, in the above-described embodiment and modifications thereof, the back yoke 22 may be omitted.

Further, in the above-described embodiment and modifications thereof, the cores 11 may be omitted and the armature 10 may have a coreless structure.

Further, the configuration of any of the above-described embodiment and modifications thereof may be applied to a linear motor in which a field magnet is a mover and armatures are a stator. In this case, the field magnet serving as the mover may be disposed at the position of the armature 10 serving as the mover of FIG. 1, and the armatures serving as the stator may be disposed at the positions of the field magnet sections 20A and 20B serving as the stator of FIG. 1. That is, the field magnet serving as the mover and the armatures serving as the stator may be disposed such that the two armatures sandwich the one field magnet in the Z-axis direction.

Further, in the above-described embodiment and modifications thereof, at least a portion of a moving path of the mover of the linear motor may include a path that extends along a curve.

### Effects

Next, effects of the permanent field magnet according to the above-described embodiment will be described.

According to the embodiment, the permanent field magnet is for a linear motor, and includes a plurality of permanent magnets, a first member, and a suppressing portion. The plurality of permanent magnet are, for example, the above-described permanent magnets 21. The first member is, for example, the above-described soft magnetic member 23. The suppressing portion is, for example, the above-described chamfered portion 21A or the above-described soft magnetic member 24. Specifically, the plurality of permanent magnets are arranged along a moving path of a mover. The mover is, for example, the above-described armature 10. The moving path is, for example, a path along the above-described X-axis direction. The first member includes a soft magnetic material and is disposed between and in contact with mutually adjacent ones of the plurality of permanent magnets. The suppressing portion is configured to suppress application of a magnetic field from an armature to each of the permanent magnets. The armature is, for example, the above-described armature 10.

Accordingly, demagnetization of the permanent field magnet having saliency can be suppressed.

According to the embodiment, the suppressing portion may be provided at at least one of one end and both ends of each of the permanent magnets in a direction along the moving path, and may be formed as a chamfered portion of a surface, facing the armature, of each of the permanent magnets. The chamfered portion is, for example, the above-described chamfered portion 21A.

Accordingly, a portion (a corner portion at each end of the surface, facing the armature, of each of the permanent magnets) where the magnetic flux of the armature tends to be applied and thus demagnetization tends to occur can be eliminated, and as a result, demagnetization of the permanent magnets can be suppressed.

According to the embodiment, the first member may be configured to contact the chamfered portion of each of the permanent magnets.

Accordingly, the first member extends to an area where a corner portion of each of the permanent magnets is chamfered. Therefore, the magnetic flux of the armature 10 can be readily concentrated in the soft magnetic member 23, and the reluctance force can be improved. As a result, the thrust of the linear motor 100 can be improved.

According to the embodiment, a groove may be provided in a surface, facing the armature, of the first member such that the groove is interposed between chamfered portions of the mutually adjacent ones of the plurality of permanent magnets. The groove is, for example, the above-described groove 23A.

Accordingly, a decrease in the thrust of the linear motor 100 associated with a short circuit of magnetic flux between the chamfered portions of the mutually adjacent permanent magnets having magnetic poles of different polarities can be reduced.

According to the embodiment, the suppressing portion may be a second member that includes a soft magnetic material and covers surfaces, facing the armature, of the permanent magnets and the first member.

Accordingly, most of the magnetic flux of the armature can pass through the second member and the first member without being directly applied to the permanent magnets. Therefore, demagnetization of the permanent magnets can be suppressed.

According to the embodiment, the thickness of the second member may be smaller than the thickness of each of the permanent magnets.

Accordingly, a situation in which magnetic flux between the mutually adjacent permanent magnets having magnetic poles of different polarities is short-circuited through the second member can be avoided.

According to the embodiment, the second member may be provided for each of the permanent magnets. The second member may cover an entire surface, facing the armature, of a corresponding one of the plurality of permanent magnets, and a portion of a surface, facing the armature, of the first member adjacent to the corresponding one of the plurality of permanent magnets. The second member may be disposed to be apart from another second member that is provided for another one of the plurality of permanent magnets adjacent to the corresponding one of the plurality of permanent magnets in a direction along the moving path.

Accordingly, a situation in which magnetic flux between the mutually adjacent permanent magnets having magnetic poles of different polarities is short-circuited through the second member can be avoided.

Although the embodiments have been described in detail above, the present disclosure is not limited to the particulars of the described embodiments, and various modifications and alterations can be made within the scope of the claimed subject matter.

What is claimed is:

1. A permanent field magnet for a linear motor, the permanent field magnet comprising:
a plurality of permanent magnets arranged along a moving path of a mover;
a first member that includes a soft magnetic material and is disposed between, and in contact with, mutually adjacent ones of the plurality of permanent magnets; and
a suppressing portion configured to suppress application of a magnetic field from an armature to each of the permanent magnets.

2. The permanent field magnet according to claim 1, wherein the suppressing portion is provided at at least one of one end and both ends of each of the permanent magnets in a direction along the moving path, and is formed as a chamfered portion of a surface, facing the armature, of each of the permanent magnets.

3. The permanent field magnet according to claim 2, wherein the first member is configured to contact the chamfered portion of each of the permanent magnets.

4. The permanent field magnet according to claim 3, wherein a groove is provided in a surface, facing the armature, of the first member such that the groove is interposed between chamfered portions of the mutually adjacent ones of the plurality of permanent magnets.

5. The permanent field magnet according to claim 1, wherein the suppressing portion is a second member that includes a soft magnetic material and covers surfaces, facing the armature, of the permanent magnets and the first member.

6. The permanent field magnet according to claim 5, wherein a thickness of the second member is smaller than a thickness of each of the permanent magnets.

7. The permanent field magnet according to claim 5, wherein the second member is provided for each of the permanent magnets, and
the second member
covers an entire surface, facing the armature, of a corresponding one of the plurality of permanent magnets, and a portion of a surface, facing the armature, of the first member adjacent to the corresponding one of the plurality of permanent magnets, and
is disposed to be apart from another second member that is provided for another one of the plurality of permanent magnets adjacent to the corresponding one of the plurality of permanent magnets in a direction along the moving path.

8. The linear motor comprising:
the permanent field magnet according to claim 1; and
the armature.
